(19) United States
(12) Patent Application Publication
(10) Pub. No.: US 2012/0275040 A1
(43) Pub. Date: Nov. 1, 2012

(54) PRECISION PARABOLIC MIRROR STRUCTURES

(75) Inventors: Lifang Li, Harbin (CN); Steven Dubowsky, Boston, MA (US); Andres George Kecskemethy Daranyi, Duisburg (DE); Abul Fazal M Arif, Dhahran (SA)

(73) Assignee: Massachusetts Institute of Technology, Cambridge, MA (US)

(21) Appl. No.: 13/095,115

(22) Filed: Apr. 27, 2011

(51) Int. Cl. G02B 5/10; B32B 3/02; B32B 3/30; B32B 3/00

(52) U.S. Cl. 359/846; 428/98; 428/192; 428/156; 428/172

(57) ABSTRACT

Parabolic Mirror. The mirror includes a flexible material with a reflective surface and a rear surface. A flexible band is in contact with the rear surface of the flexible material. The bending stiffness of the band as a function of distance along its length is selected so that the band and the flexible material in contact therewith assume a parabolic shape when ends of the band are moved toward one another. In a preferred embodiment, the bending stiffness of the band is achieved by controlling the second moment of area of the band along its length. The second moment of area may be adjusted by altering the width of the band along its length or by altering the thickness of the band along its length, or a combination of the two.

### BACKGROUND OF THE INVENTION

This invention relates to concentrator mirrors and more particularly to methodology and structure for shaping such a mirror into a parabolic shape using a band having a selected bending stiffness along its length.

Solar mirror collectors are a major subsystem of many solar energy systems, particularly for solar thermal generators [1]. Numbers in brackets refer to the references included herewith. The contents of all of these references are incorporated herein by reference in their entirety. Large thermal systems may use many collectors covering large sites [2], as shown in FIG. 1. Collectors generally consist of concentrating parabolic mirrors 10, an absorber tube 12 and a supporting structure, which is often equipped with a solar tacking mechanism. They are called parabolic trough collectors (PTCs) [2], and are shown in schematic form in FIG. 2.

The parabolic shaped mirror 10 (reflector) focuses the sunlight onto a linear tube 12 located at the mirror's focal line that contains a working fluid that absorbs the solar energy and carries it to some thermal plant, such as a Rankine or a Sterling heat engine [3]. The mirror 10 is usually supported by a structure that often contains an active tracking mechanism that keeps the mirror pointed towards the sun.

The mirror shape must be precise enough to ensure that the reflected sunlight is focused on the absorber tube. As shown in FIG. 3 and FIG. 4, it has been long known that if the shape of the mirror is not a parabola, the light will not precisely focus on a small tube [5]. There are important practical reasons to keep the absorber tube small, such as cost, thermal radiation and convection losses [6].

Mirror precision is important and conventional methods to fabricate precision parabolic mirrors are complex and costly. The reflectivity of the surface materials is an important factor in the optical efficiency. In solar energy applications, back silvered glass plates, anodized aluminum sheets and aluminized plastic films serve as reflectors. They are widely commercially available [7-9]. Films are usually adhered to a supporting material such as aluminum [10]. However, the supporting material must be held with a precision parabolic shape by some supporting structures. Parabolic dies or precision milled mirrors are usually required for these solar concentrators. However, they are often heavy and complex, which makes them unsuitable for rapidly deployable and portable systems. Moreover, their shape cannot be adjusted in real-time to compensate for thermal variations, etc. [11, 12]. Many future solar power plants will use very large numbers of parabolic mirror collectors, as shown in FIG. 1. Hence, methods to design precision parabolic mirrors at relative low cost are potentially of great commercial importance [13-15].

In our past work, we have used distributed forces to form parabolas from simple circular shapes. FIG. 5 shows a set of distributed forces that will make a circular mirror into an approximately parabolic shape. FIG. 5(a) shows the shape adjustment required to forming a parabola from a rolled circular sheet material. FIG. 5(b) shows an example of the required forces when 11 distributed forces are applied. While this approach can achieve the desired result, it requires far more forces than the 11 shown to achieve a smooth parabolic shape, and the implementation of the applied forces in a real system is very complex. See, reference [16]. Hence a new approach that is simpler to implement is disclosed herein.

### SUMMARY OF THE INVENTION

In a first aspect, the invention is structure that forms a substantially parabolic shape upon deformation. The structure includes a flexible band having a length and two ends, wherein the bending stiffness of the band as a function of distance along its length is selected so that the band assumes a substantially parabolic shape when the two ends of the band are moved toward one another. In a preferred embodiment, the selected bending stiffness of the band as a function of distance along its length is achieved by controlling the second moment of area of the band along its length. The second moment of area may be controlled by altering the width of the band along its length or by altering the thickness of the band along its length, or a combination of the two.

In yet another aspect of this part of the invention, the selected bending stiffness of the band as a function of distance along its length is achieved by punching holes in the band in approximately continuous patterns. The bending stiffness of the band may also be achieved by controlling the modulus of elasticity of the band material along its length. The thickness of the band may be altered by constructing the band of layers. In a preferred embodiment of this aspect of the invention, the structure further includes a flexible material with a reflective surface in contact with the flexible band wherein the band deforms the flexible material to form a parabolic mirror.

In yet another aspect of the invention, a parabolic mirror includes a flexible material with a reflective surface and a rear surface. A flexible band is in contact with the rear surface of the flexible material. The bending stiffness of the band as a function of distance along its length is selected so that the band and the flexible material in contact therewith assume a parabolic shape when ends of the band are moved toward one another. It is preferred in this aspect of the invention that the stiffness of the flexible material be less than the stiffness of the flexible band. In a preferred embodiment, the parabolic mirror according to this aspect of the invention further includes an absorber tube located to receive solar energy reflected by the mirror and to capture a selected fraction of the reflected solar energy.

### BRIEF DESCRIPTION OF THE DRAWING

FIG. 1 is a perspective view of a prior art solar mirror collector field.

FIG. 2 is a schematic illustration of a prior art solar gh collector.

FIG. 3a is schematic illustration of a reflecting mirror with an ideal parabolic cross section.

FIG. 3b is a schematic illustration of a reflecting mirror with a non-ideal cross section (circular).

FIG. 4 is an illustration of a Leonardo Da Vinci concave mirror.

FIG. 5a is a schematic illustration showing the shape adjustment required to form a parabola from a rolled circular sheet material.

FIG. 5b is a schematic illustration of the required forces when 11 distributed forces are applied to form the material into a parabola.

FIG. 5a is a schematic illustration of the band-mirror structure according to an embodiment of the invention.

FIG. 6b is a schematic illustration of an initial flat band having a varying profile cross section.

FIG. 6c is a schematic illustration showing a deformed band's vertical shape.

FIG. 7 is a schematic illustration showing various parameters involved with band bending.

FIG. 8a is a schematic illustration of controlling bending stiffness by varying thickness of band.

FIG. 8b is a graph of thickness versus length for a band according to an embodiment of the invention.

FIG. 9 is a schematic illustration showing a laminating approach to adjusting thickness for an embodiment of the band.

FIG. 10 is a schematic illustration of a parabolic band obtained by changing the width.

FIG. 11 is a schematic illustration to define focal error.

FIG. 12 is an illustration for focal error analysis.

FIG. 13 is a graph of width versus length for a band shape based on a finite element model.

FIG. 14 is a schematic illustration of a physical model of a deformed band as a result of finite element analysis.

FIG. 15 is a schematic illustration of analytic optimized bands as a result of the finite element analysis results.

FIG. 16 is a graph showing ray tracing using finite element analysis results.

FIG. 17 is a graph of width versus length of a band that shows both finite element analysis optimized and an analytic optimized band.

FIG. 18 is a ray tracing for a finite element analysis-optimized band.

FIG. 19 is a graph of focal error versus distance showing the maximal focal error of an optimized band.

FIG. 20 is a pictorial representation of an experimental system disclosed herein.

FIG. 21 is a photograph of a rectangular and an optimized band according to the invention.

FIG. 22a is a photograph illustrating a band-mirror combination according to the invention concentrating sunlight.

FIG. 22b is a photograph showing a burn mark at the focal line on a plastic absorber used with an embodiment of the invention.

FIG. 23a is a photograph of a band on the vertical direction convened into a monochrome image.

FIG. 23b is a graph comparing a fitted curve with an ideal parabola.

FIG. 24 is a graph of focal error versus distance showing ray tracing using an optical method.

FIG. 25 is a graph of focal error versus distance using an optical method.

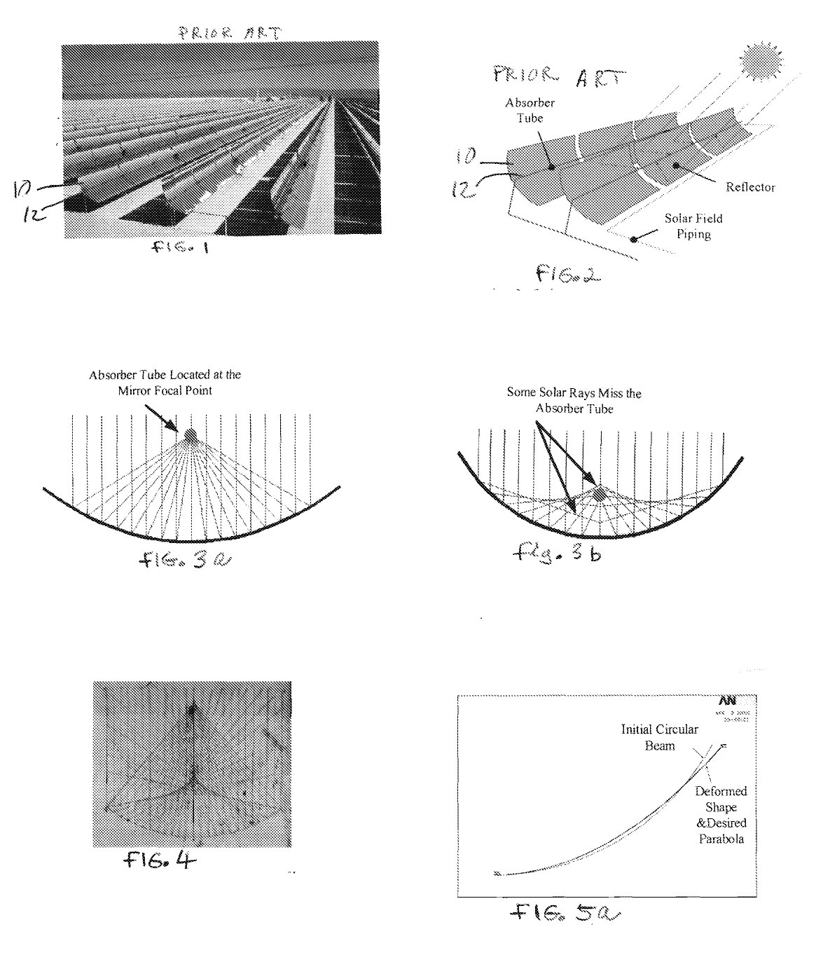

### DESCRIPTION OF THE PREFERRED EMBODIMENT

The approach presented herein for designing and fabricating precision parabolic mirrors as shown in FIG. 6a consists of a thin, flat, very flexible metal sheet 14 with a highly reflective surface 16 and a “backbone” band 18 attached to its rear surface. The figure of the “backbone” band 18 is optimized to form the sheet 14 into a precision parabola when the two ends of the band 18 are pulled toward each other by a predetermined amount. This result can be achieved using a simple spacer rod or an active position control system when high precision requires real-time adjustment.

An analytical model is used to optimize the band's shape after it is deformed so that it is parabolic. The band 18 is cut from a flat plate with a stiffness that is substantially higher than the mirror sheet 14. As discussed below, the elastic properties of the band 18 can also be tuned to account for the mirror plate's stiffness.

It is also shown herein that the band 18 profile can be determined numerically using Finite Element Analysis (FEA) combined with a numerical optimization method. These numerical results agree well with the analytical solutions.

Rather than optimizing the band stiffness by varying its width, its thickness, (s), can also be optimized to achieve the desired shape, see FIG. 6(b). In some designs it may be desirable to vary both the band's thickness t(s) and width b(s) on the initial flat band. In general, varying the thickness, t(s), would be a more costly manufacture than a uniform thickness hand. However the thickness, as a function of length, t(s), can be manufactured more simply by using a multi-layer band that approximates the variable thickness solution.

Moreover, the bands can also be optimized by punching holes on uniform width bands in approximately continuous patterns. However, this could create stress concentration problems in areas near the holes.

The backbone-band concept's validity is demonstrated herein by Finite Element Analysis and by laboratory experiments. In the experiments, mirror bands of various profiles were fabricated and tested in the laboratory using a collimated light source (that emulates direct sunlight) and outdoors in natural sunlight.

Our studies suggest that this concept would permit essentially mirror elements to be easily fabricated and efficiently packaged and shipped to field sites and then assembled into the parabolic mirrors for mirror solar collectors with potentially substantial cost reductions over current technologies.

Here a model based on Euler-Bernoulli beam theory of a flat band that will form a desired parabolic shape by moving its two ends toward each other to a given distance, L, is presented, see FIG. 6(a). It is assumed that by proper selection of the bending stiffness EI(s) of the band as a function of the distance, s, along its length a parabolic shape results when the band is deformed, where I(s) is the second moment of area of the band and E(s) is the modulus of elasticity of the band material.

For the analytical derivations, the following assumptions are made.
The thickness t(s) is much smaller than the length S of the band, so while the deflection is large (rotation and displacement), the shear stresses are small and hence Euler-Bernoulli beam equations can be used.
The final distance L (parabolic chord length) between the two band ends is specified, and the rim angle of the desired parabola is given as θ, see FIG. 6(c).
The end deflection is achieved by the application of forces, F, during assembly and held in place by spacer rods, or an active control system.
   If the focal length of the parabolic mirror is f, then the desired shape of the deformed band is given by the well-known relationship, see FIG. 6(c):

$$z = \frac{{x}^{2}}{4 f} ( - \frac{L}{2} ≦ x ≦ \frac{L}{2} ) \qquad ( 1 )$$

The depth d of the parabola can be calculated as:

$$d = \frac{{( L \text{/} 2 )}^{2}}{4 f} \qquad ( 2 )$$

Considering the energy efficiency of the mirror, a shallow parabola is selected, hence d≦f. The angle θ of the parabola is given by:

$$θ = 2 arctan ( \frac{L \text{/} 2}{f - d} ) \qquad ( 3 )$$

and the arc length s given by:

$$s ( x ) = {\int }_{0}^{x} \sqrt{1 + {( \frac{u}{2 f} )}^{2}} d u \qquad ( 4 )$$

where u is a dummy integration variable along the longitudinal direction of the beam.

Hence the initial flat band length S is given by:

$$S = 2 {\int }_{0}^{L} \sqrt[2]{1 + {( \frac{u}{2 f} )}^{2}} d u \qquad ( 5 )$$

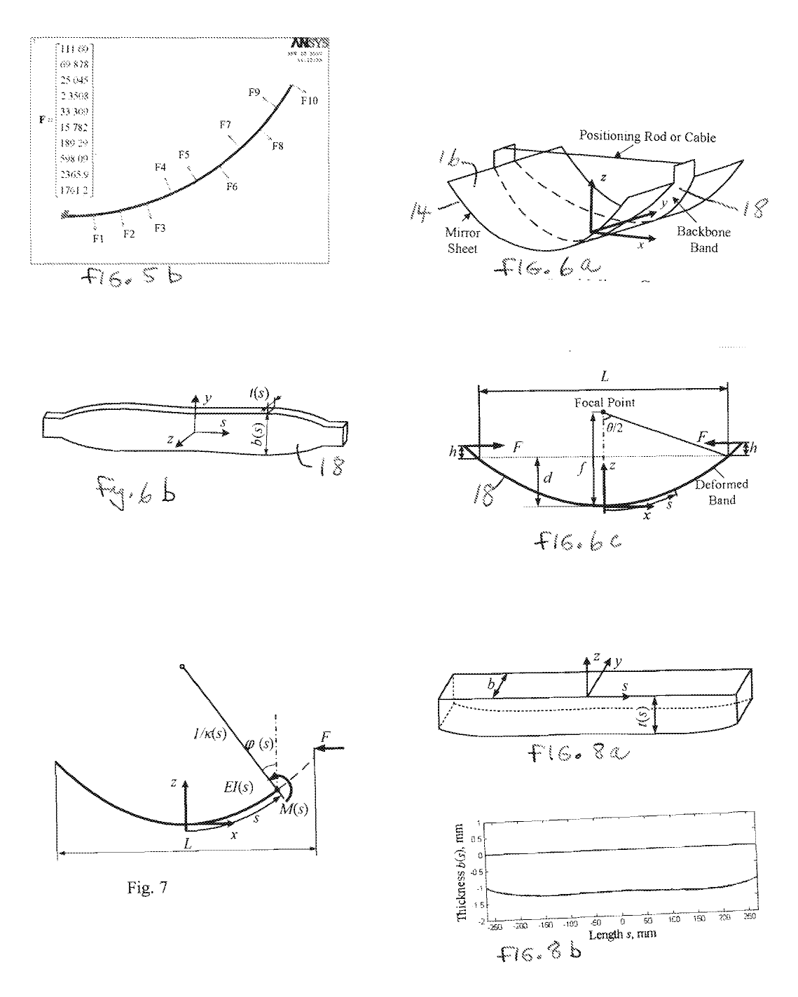

Based on the above assumptions, Euler-Bernoulli beam theory applies, and the deflection of the beam are governed by [17]:

$$M ( s ) = EI ( s ) \frac{\partial φ ( s )}{\partial s} = EI ( s ) κ ( s ) \qquad ( 6 )$$

where M(s) is the bending moment on the band, φ(s) is the rotation of band surface normal, and κ(s) is the curvature of the final band shape, see FIG. 7.
The curvature of the parabola κ(s) is given by:

$$κ ( s ) = \frac{1}{2 f} {( 1 + {ln}^{2} ( s / 2 f + \sqrt{{s}^{2} / 4 {f}^{2} + 1} ) )}^{\frac{3}{2}} \qquad ( 7 )$$

From Equation (6), I(s) is obtained as:

$$I ( s ) = \frac{M ( s )}{E κ ( s )} \qquad ( 8 )$$

With the thickness t(s) and width b(s) varying with length s, the second moment of area I(s) for a rectangular cross section is given by:

$$I ( s ) = \frac{b ( s ) {t}^{3} ( s )}{12} \qquad ( 9 )$$

As shown in FIG. 6 (c), the bending moment in the band can be calculated as a function of x as:

$$M ( x ) = F \cdot ( h + d - \frac{{x}^{2}}{4 f} ) \qquad ( 10 )$$

Thus, the bending moment along the band length s is governed by:

M(s)=F·(h+d−f·ln²(s/2f+{square root over (s²/4f²+1))}) (11)

It is well-known that loading a band with collinear external forces does not result in a parabolic shape. However, it is possible to shape the band's cross section to form a parabola shape when its ends are pulled together by horizontal threes.

In this process, it will be assumed that both the thickness and the bending stiffness of the thin mirror sheet are much smaller than the corresponding quantities of the band. In these cases, the shape can be tuned to a parabola by varying the band's thickness t(s), its width b(s) or both as a function of s, see FIG. 6 (b) (c). More general situations with non-negligible mirror sheet stiffness and/or bending stiffness can be considered by applying the Finite Element optimization method described later in this patent application.

In a first case, t(s) changes and the width h(s) is assumed to be a constant h, as shown in FIG. 8. Thus, the thickness t(s) as a function of the width b and the second moment of area the band is:

$$t ( s ) = \sqrt[3]{\frac{12 I ( s )}{b}} \qquad ( 12 )$$

Substituting Equation (7 (11) into Equation (12) yields the thickness:

$$t ( s ) = \sqrt[3]{\frac{M ( s )}{bE κ ( s )}} = \sqrt[3]{\frac{12 F ( h + d - f {ln}^{2} ( s / 2 f + \sqrt{{s}^{2} / 4 {f}^{2} + 1} ) )}{bE κ ( s )}} \qquad ( 13 )$$

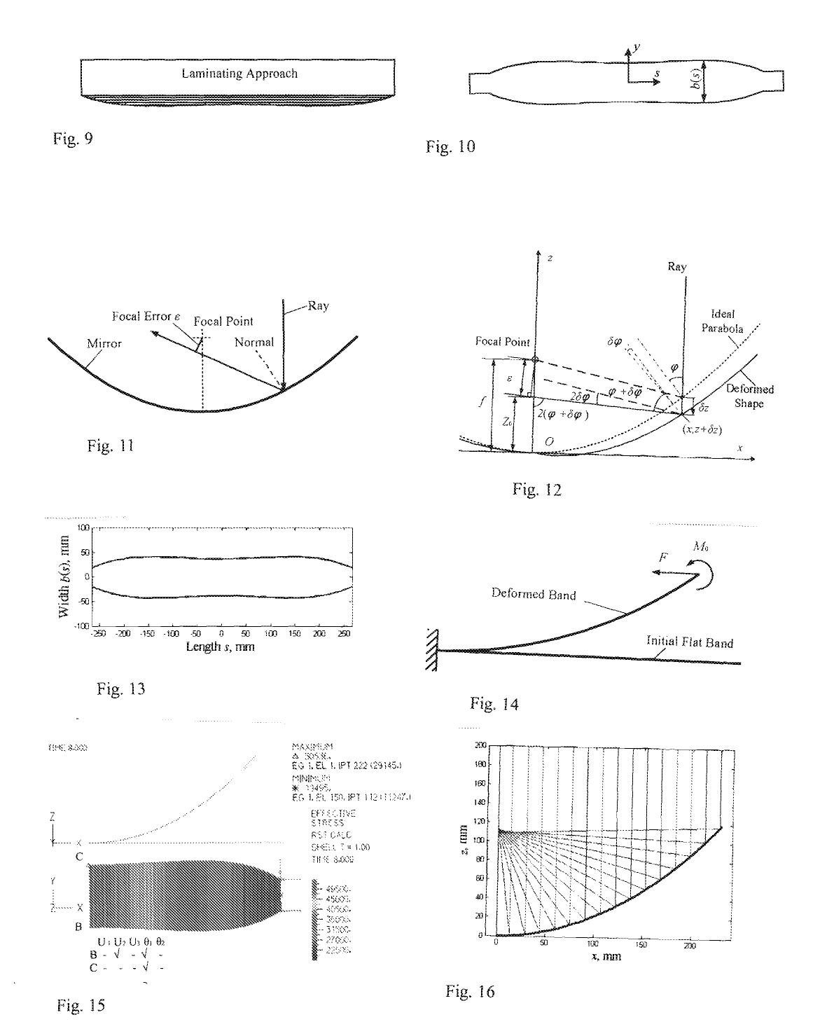

For a thick band, large shear stresses could result and produce non-negligible errors. Moreover, there might be an error induced by the difference of the curvature of the neutral line and the curvature of the upper surface. These errors are of second order and neglected in the present context. Also varying the thickness on the band is difficult and expensive to fabricate. A varying thickness can be approximated by constructing the band from layers, see FIG. 9. This laminating approach is probably not economically viable compared to the method discussed below.

A more cost-effective way to vary the area moment of inertia of the band is to vary its width as a function of s, b(s), with the band's thickness, t, held constant, see FIG. 10. In this case, the band width is:

$$b ( s ) = \frac{12 I ( s )}{{t}^{3}} \qquad ( 14 )$$

After substituting Equations (7), (8) and (11) into Equation (14), the ideal band width is obtained as the explicit solution:

$$b ( s ) = \frac{12 M ( s )}{{Et}^{3} κ ( s )} = \frac{12 F ( h + d - f {ln}^{2} ( s / 2 f + \sqrt{{s}^{2} / 4 {f}^{2} + 1} ) )}{{Et}^{3} κ ( s )} \qquad ( 15 )$$

Such a design would be much easier to manufacture than a varying thickness design.

Clearly it is possible to combine the above two approaches by varying both band thickness and width. This might be done when other design constrains need to be met. The bands can also be optimized by punching holes on uniform width and thickness bands in approximately continuous patterns. However, the holes will produce a stress concentration problem.

In addition, it is clear that similar results can be achieved by varying the material properties as a function of s, though this does present some significant manufacturing challenges. An analysis of mirror performance for a mirror made according to the invention will now be presented. For this analysis, it is assumed that the mirrors are actively tracking the sun. In this case, the sunlight will be parallel to the axis of the parabola. The objective is to calculate the distance of the reflections of the rays from the focal point where the absorber tube will be mounted. The focal error, ε, is defined as the distance from the focal point to a reflection ray, see FIG. 11. This error determines the diameter of the absorber tube for the or to insure that all the solar energy intersects the absorber tube. Other metrics can be developed such as the percent of the energy that falls on a given absorber tube. The discussion of these metrics is beyond the scope of this disclosure. Assuming small variations from the ideal parabolic profile, the focal error can be determined as follows (see FIG. 12).

For an arbitrary ray at horizontal position x, assume that the position error of the actual deformed shape is δz, and that the angular error of the surface normal is δφ. Taking z as the vertical coordinate of the ideal parabola and X, Y as the running coordinates of the reflection ray, one obtains:

$$Z ( X ) = z + δ z - ( X - x ) tan ( \frac{π}{2} - 2 φ - 2 δ φ ) \qquad ( 16 )$$

When X=0, Z₀ is obtained as:

$${Z}_{0} = z + δ z - x tan ( \frac{π}{2} + 2 φ + 2 δ φ ) \qquad ( 17 )$$

The focal error is then obtained as:

ε(x,δz,δφ)=(f−Z₀)sin(2(φ+δφ)) (18)

As it can be seen, the focal error is positive when the reflected ray passes below the focal point and negative when it passes above the focal point.
The maximal focal error εₘₐₓ is defined as the maximum of the absolute values of the focal errors for all rays entering the mirror's aperture.

The performance of solar concentrators is often expressed in terms of their ability to concentrate collimated light, called concentration ratio, C, as a function of the chord length L and the focal diameter d_{F}, 100% of light entering the mirror to reach the absorber tube. Here, for a given chord length, L, the maximum focal error, εₘₐₓ, is chosen as a power precision performance metric.

The analytical Euler-Bernoulli beam model shows the feasibility of the band-shaping approach for relatively simple cases. A more general approach, suitable also for the treatment of more involved cases (e.g. non-negligible bending stiffness of mirror sheet), is to perform a numerical shape optimization procedure based on Finite Element Analysis (FEA), as discussed below. The objective of the optimization is to minimize the maximum focal error by varying I(s):

$${min}_{I ( s )} {ɛ}_{max} \qquad ( 19 )$$

In order to find the optimal profile I(s), we describe it via a finite Fourier series expansion:

$$I ( s ) = {I}_{0} + {\sum }_{n = 1}^{N} {a}_{n} cos ( \frac{n π s}{L} ) \qquad ( 20 )$$

where only even terms need to be regarded as the function I(s) is symmetric with respect to s.
The optimization task is to find the optimal coefficients

A=[I₀a₁a₂ . . . N] (21)

such that when multiplied with the spatial shape vector:

B(s)=[1 cos(πs/L)cos(2πs/L) . . . cos(Nπs/L]^{T} (22)

the resulting area moment of inertia

I(s)=AB(s) (23)

will minimize the maximal focal error εₘₐₓ obtained after performing the corresponding FEA computation and evaluating the focal errors from the resulting bent band. This task corresponds to an unconstrained optimization problem with design variables A and cost function εₘₐₓ, for which several well-known solution schemes exist. We chose here to apply an exact Newton search in which at each optimization step the Jacobian is computed by repeated evaluations of the FEA analysis for small variations of each of the coefficients in A and the corresponding next estimate of A⁽ⁱ⁾ is computed such that the linear approximation of the maximal focal error vanishes.

A case study will now be presented. In this case study, a parabolic band based on varying width is presented. The optimization is obtained using both the analytical formulation set out above and the Finite Element based numerical optimization method just described. In this case, the rim angle θ is taken as 180°. Hence d is equal to f and L is equal to 4f.

Using the given parameters and Equation (15), the band width as a function of s is:

$$b ( s ) = \frac{12 F ( h + f - f {ln}^{2} ( s / 2 f + \sqrt{{s}^{2} / 4 {f}^{2} + 1} ) )}{{Et}^{3} κ ( s )} \qquad ( 24 )$$

With the parameters in Table 1, the ideal analytical shape shown in FIG. 13 is obtained.

TABLE 1
Band Parameters

| Parameters | Value | |
|---|---|---|
| Material | Spring steel | |
| Focal length f (mm) | 116.1 | |
| Rim angle θ (degree) | 180 | |
| Chord length L | 464.3 mm | (18.3 inch) |
| Horizontal load F (N) | 9.5 | |
| Load position h | 25.4 mm | (1 inch) |
| Young's modulus E (MPa) | 210,000 | |
| Thickness t | 0.7937 mm | ( 1/32 inch) |

A Finite Element model of the analytically shaped band was developed and implemented in ADINA [18-20]. FIG. 14 shows the boundary conditions and the force and moment loading of the FEA analysis. The band is modeled as a shell bending problem. As shown in FIG. 15, U₁, U₂ and U₃ are the translations about x, y and z axes, θ₁ and θ₂ are the rotations about x and v axes, The sign “√” means the degree of freedom is active and “−” means it is fixed. Boundary conditions are shown at points B and C. The rotation about z axis is fixed for the whole model, in the model, it is assumed that the deformation is large and that strains are small, and that no plastic deformation occurs. The horizontal force, F, and the moment M₀, which is equal to Fh, are divided into two halves and applied as concentrated forces at the two end nodes. The loads were incrementally increased to the final value in 8 steps. The figure also shows the deflection and the stress distribution. The maximum equivalent Mises stress is 348.52 MPa (50536 psi shown in FIG. 15), which is below the yield stress of 1050 MPa for the chosen material (spring steel 38Si6).

To evaluate the precision of the result, ray tracing using the FEA deformed shape of the mirror was carried out, see FIG. 16. Assuming collimated rays entering the mirror along the axis of the parabola, the reflected rays are traced based on the normal rotations φ(s) and displacements [x(s)z(s)] from the FEA results. The focal error is calculated using Equation (19). The resulting maximum error, εₘₐₓ, for the analytically shaped band was 1.85 mm. This means the diameter of the absorber tube, d_{F}, should be at least 3.70 mm if 100% of the energy is to be absorbed. The FEA results show that the band based on the analytical formulation is not a perfect parabola. A FEA optimized band was calculated using the shape optimization method discussed above. As initial guess, a rectangular band with width, b, 76.2 mm (3.0 inches) and thickness, t, 0.7937 mm ( 1/32 inch) was employed. The optimization procedure converged after 9 iterations with a termination condition of 10⁻⁴ for the magnitude of the increment ΔA of the design parameter vector.

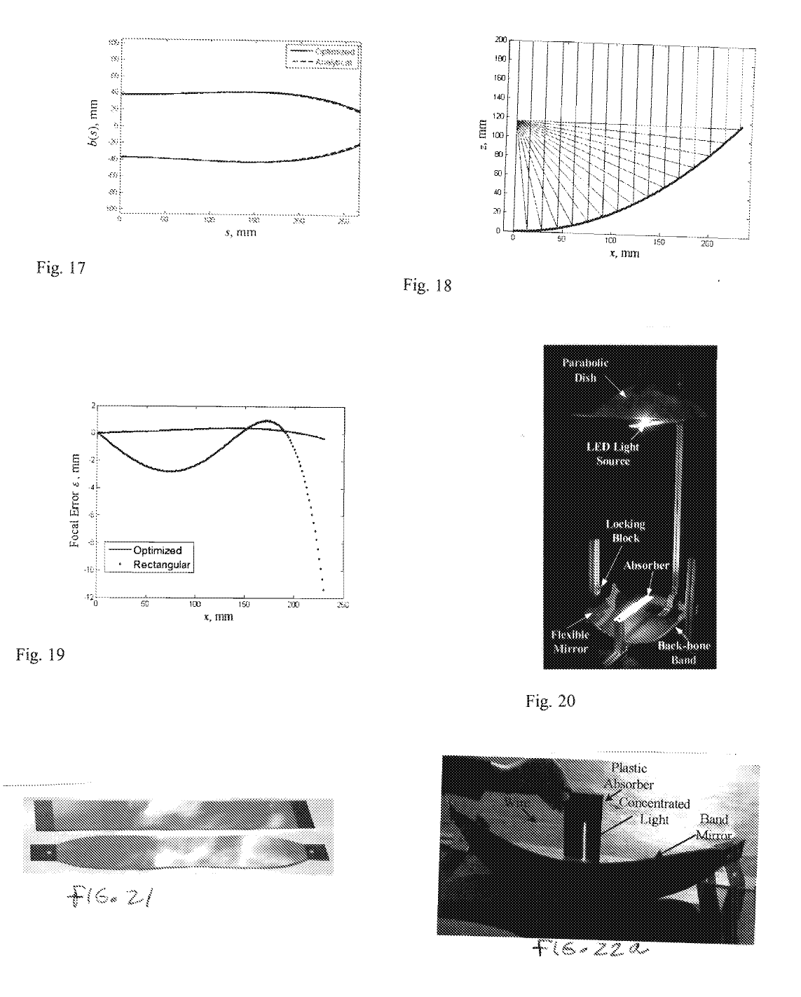

FIG. 17 shows the band width h(s) as a function of band length s for the optimized FEA and the analytical optimized results. It can be seen that the numerical FEA approach converges to a similar shape as the analytical approach. The ray tracing for the FEA optimized band is shown in FIG. 18. The maximum focal error is 0.38 mm, approximately a factor of five smaller than the idealized analytical result. In order to assess the improvement of solar energy collection properties of the shape-optimized band and a simple rectangular hand, a FEA analysis of a rectangular band was carried out. The results shows that the maximal focal error of the optimized band is a factor of 10 smaller than that of the rectangular band, see FIG. 19.

The results of the previous optimization were validated experimentally. The experimental system consists of two main components: a flexible mirror with varying-width backbone band and a collimated light source consisting of a parabolic dish with an LED light source at its focal point and an absorber located on the mirror's focal line, see FIG. 20 Two locking blocks are used to construct the mirror's chord length, L, to its desired value. The concentration absorber was made from a semitransparent sparent white plastic plate with the dimensions 1.5×26 inches.

The FEA optimized band was cut from a piece of 0.7937 in ( 1/32 inch) spring steel sheet using a water jet cutter with tolerance ±0.0254 mm (± 1/1000 inch). FIG. 21 shows the backbone band with optimized width and a simple rectangular band. FIG. 22 (a) shows the band mirror concentrating sunlight. A wire is used to fix the chord length, L, and a black plastic absorber was placed at the focal line of the band. The width of the focal area is less than 3 mm for 100% energy to be collected. The plastic absorber was quickly burnt by the concentrated light. The burn mark is shown in FIG. 22 (b). The width of burn is less than 2 mm. The concentration ratio of the optimized band, C, is about 154.8 under sunlight. The result is much higher than those achieved by most current industrial parabolic mirror solar concentrators.

For comparison, the non-optimized rectangular band (see FIG. 21) had about 5 mm focal width with only about 90% energy collected. It was not possible to measure the focal width of 100% collection as the image was outside of the measurement limits. The focal width of the optimized band is 4.6 mm measured in the laboratory for 100% of the rays collected. And the rectangular band focal width is 10.3 mm with about 90% rays collected.

The parabolic shape of the deformed hand was measured in two ways, an edge finder on a CNC milling machine and an optical method. However, since the band was thin and thus highly compliant, the edge finder induced deformation errors that made the measurements unfit for focal error determination.

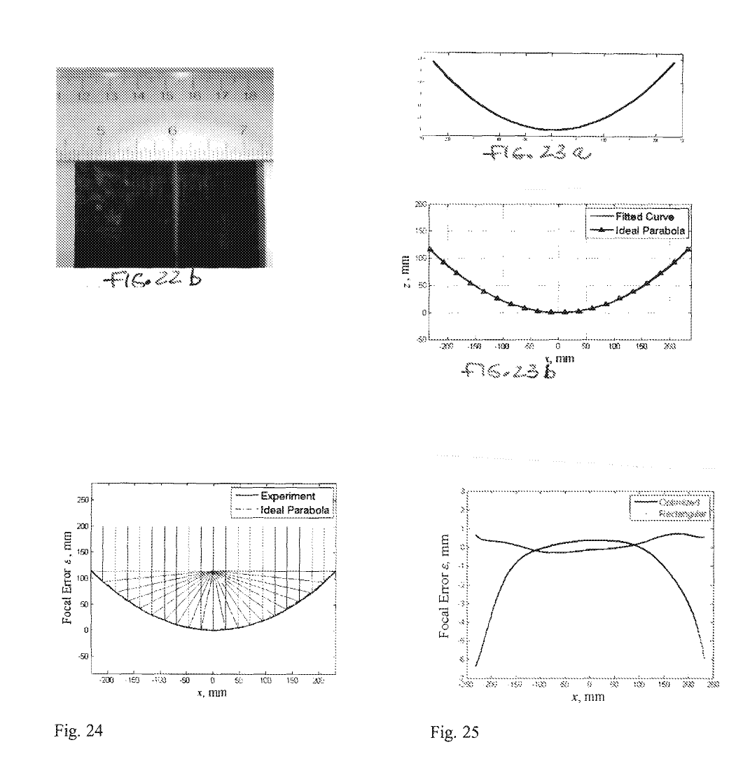

Thus, the optical method, in which no physical contact s made with the band, was further pursued. In this method, a photograph of the band on the vertical direction was taken and converted into a monochrome image (black and white). The threshold figure yields a high contrast black and white digital image, see FIG. 23 (a). This image was then fitted with a high degree polynomial function and thus yielded a shape that closely matched the predicted contour, see FIG. 23 (b). As before, the shape was used as the ray tracing algorithm, see FIG. 24. The focal error was obtained, see FIG. 25. Note that any measured rigid body rotations and translations of the mirror shape in FIG. 25 due to calibration issues have been eliminated from the results shown. The maximum focal error is small, 0.72 mm, compared with 6.41 mm of the rectangular band.

In this disclosure, the design and manufacture of a simple and low cost precision 365 parabolic mirror solar concentrator with an optimized profile backbone band is presented. The band is optimally shaped so that it forms a parabola when its ends are pulled together to a known distance. It could be fabricated and shipped flat, and onsite its ends would be pulled together to distance by a wire, or rod, or actively controlled with a simple control system. Varying width of the band as a function of its length appears to be the most cost-effective way to fabricate the band. A method for calculating the optimized profile band is presented using an analytical model and Finite Element Analysis. The backbone band was experimentally evaluated using the metric of the maximum focal error and focal width. The experimental results showed a factor of 10 improvement in the performance of optimized band compared to a simple rectangular band. We expect that this approach would be a cost-effective and simple technology for the design and fabrication of high precision parabolic mirror solar concentrators for solar energy applications.

### Nomenclature

aₙ=shape coefficients
A=shape coefficients vector
A⁽ⁱ⁾=the i^{th} of shape coefficients vectors of optimization
B(s)=shape vector respect to s axis (mm)
b(s)=band width with respect to s axis (mm)
b(x)=band width with respect to x axis (mm)
C=solar concentration ratio (dimensionless)
d=depth of PTC (mm)
d_{F}=diameter of focal area (mm)
E=Young's modulus (MPa)
f=focal length (mm)
F=horizontal force (N)
h=force position (mm)=
I₀=initial second moment of area of rectangular band (m⁴)
I(x)=second moment of area respect to x axis (m⁴)
I(s)=second moment of area respect to s axis (m⁴)
L=parabolic chord length (mm)
M(x)=bending moment respect to x axis (MPa)
M(s)=bending moment respect to s axis (MPa)
s=band arc length (mm)
S=initial flat band length (mm)
x, y, z=Cartesian coordinates
X,Y,Z=Cartesian coordinates

### Greek Symbols

δz=band shape error on z direction (mm)
δφ=normal angle error (rad)
ε=focal error (mm)
εₘₐₓ=maximum focal error (mm)
θ=rim angle (deg)
φ(s)=rotation of band normals from flat (rad)

### REFERENCES

[1] Romero M., Martinez D. and Zarza E., 2004, “Terrestrial Solar Thermal Power Plants: On the Verge of Commercialization”, 4th Int. Conf. on Sol. Power from Space, Granada, 385 pp. 81-89.
[2] “Solar Energy System Design”, http://www.powerfrom thesun.net/chapter1/Chapter1.htm.
[3] Quaschning V., Muriel M. B., 2001, “Solar Power—Photovoltaics or Solar Thermal Power Plants?”, VGB Congress Power Plants, Brussels.
[4] http://commons.wikimedia.org/wiki/File:Parabolic_trough.svg.
[5] Leonardo da Vinci, 1474-1518, “The Codex Arundel”, The British Library, London.
[6] Hatwaambo S., Hakansson, H. J. Nilsson and Karisson B., 2008, “Angular Characterization of Low Concentrating PV-CPC Using Low-cost Reflectors”. Solar Energy Materials and Solar Cells, Volume 92, Issue 11, pp. 1347-1351.
[7] Thomas A. and Guven H. M., 1993, “Parabolic Trough Concentrators design, Construction and Evaluation”, Energy Convers. Mgmt, Vol. 34, No. 5, pp. 401-416.
[8] Kennedy C., Terwilliger K., Milbourne M., 2005, “Development and testing of solar reflectors”, Conference Paper NREL Report CP-520-36582, Golden Colo.
[9] Kennedy C., Terwilliger K., 2005, “Optical Durability of Candidate Solar. Reflectors”, Journal of Solar Energy Engineering, Vol. 127, No. 2, pp. 262-269.
[10] http://www.reflectechsolar.com/home.html.
[11] A. Fernández-García, Zarza E., Valenzuela L. and Pérez M., 2010, “Parabolic-mirror Solar Concentrators and Their Applications”, Renewable and Sustainable Energy Reviews, Volume 14, Issue 7, 2010, pp. 1695-1721.
[12] Winter C. J., Sizman R. and Vant-Hull, L. 1991, “Solar Power Plants—Fundamentals, Technology Systems and Economics”, Springer-Verlag, Berlin.
[13] Price H., Lüpfert E., Kearney D., Zarza E., Cohen G. and Gee R. et al., 2002, “Advances in Parabolic Mirror Solar Power Technology”, J Sol Energy Eng 124, pp. 109-117.
[14] Geyer M., Lüpfert E., Osuna R., Esteban A., Schiel W. and Schweitzer A. et al., 2002, “EUROMIRROR—Parabolic Mirror Concentrator Developed for Cost Efficient Solar Power Generation”, SolarPACES, 11th Int. Symp. On Conc. Sol. Power and Chem. Energy Technol., Zurich.
[15] Kearney D. W., 2007, “Parabolic or Collector Overview”, In: Parabolic Mirror Workshop at the NREL.
[16] Pashah S., Arif A. F. M., 2010, “FE Simulation of a Parabolic Collector”, Stress Analysis Laboratory Report, King Fand University of Petroleum & Minerals, Dhahran, Saudi Arabia.
[17] Mutyalarao M., Bharathi D., Nageswara Rao B., 2010, “Large deflections of a cantilever bea under an inclined end load”, Appl. Math. Comput., doi:10.1016/j.amc.
[18] K. J. Bathe, 1996, Finite Element Procedures, Prentice Hall.
[19] D. Chapelle, K. J. Bathe, 2003, The Finite Element Analysis of Shells—Fundamentals, Springer.
[20] ADINA R&D, Inc, 2000, ADINA User Interface Primer. ADINA R&D, Inc.

What is claimed is:

1. Structure that forms a substantially parabolic shape upon deformation comprising:
a flexible band having a length and two ends, wherein the bending stiffness of the band as a function of distance along its length is selected so that the band assumes a substantially parabolic shape when the two ends of the band are moved toward one another.

2. The structure of claim 1 wherein the selected bending stiffness of the band as a function of distance along its length is achieved by controlling the second moment of area of the band along its length.

3. The structure of claim 2 wherein the second moment of area is controlled by altering the width of the band along its length.

4. The structure of claim 2 wherein the second moment of area is controlled by altering the thickness of the band along its length.

5. The structure of claim 3 wherein the width of the band as a ction of distance along its length is
$$b ( s ) = \frac{12 M ( s )}{{Et}^{3} κ ( s )} = \frac{12 F ( h + d - f {ln}^{2} ( s / 2 f + \sqrt{{s}^{2} / 4 {f}^{2} + 1} ) )}{{Et}^{3} κ ( s )} .$$

6. The structure of claim 4 wherein the thickness of the band as a function of distance along its length is
$$t ( s ) = \sqrt[3]{\frac{M ( s )}{bE κ ( s )}} = \sqrt[.3]{\frac{12 F ( h + d - f {ln}^{2} ( s / 2 f + \sqrt{{s}^{2} / 4 {f}^{2} + 1} ) )}{bE κ ( s )}} .$$

7. The structure of claim 2 where the second moment of area is controlled by altering a combination of width and thickness of the band along its length.

8. The structure of claim 1 wherein the selected, bending stiffness of the band as a function of distance along its length is achieved by punching holes in the band in approximately continuous patterns.

9. The structure of claim 1 wherein the selected bending stiffness of the band as a function of distance along its length is achieved by controlling the modulus of elasticity of the band material along its length.

10. The structure of claim 4 wherein thickness of the band is altered by constructing the band of layers.

11. The structure of claim 1 further including a flexible material with a reflective surface in contact with the flexible band wherein the band deforms the flexible material to form a parabolic mirror.

12. Parabolic mirror comprising:
a flexible material with a reflective surface and a rear surface;
a flexible band in contact with the rear surface of the flexible material;
wherein the bending stillness of the band as a function of distance along its length is selected so that the band and the flexible material in contact therewith assume a parabolic shape when ends of the band are moved toward one another.

13. The parabolic mirror of claim 12 wherein e stiffness of the flexible material is less than the stiffness of the flexible band.

14. The parabolic mirror of claim 2 further including an absorber tube located to receive solar energy reflected by the mirror and sized to capture a selected fraction of the reflected solar energy.
